(19) United States
(12) Patent Application Publication
(10) Pub. No.: US 2015/0261844 A1
(43) Pub. Date: Sep. 17, 2015

(54) SYSTEM AND METHOD FOR RECOMMENDING PEOPLE TO MEET OR PLACES TO VISIT BASED ON INTERESTS OF THE USER

(71) Applicant: Katrina Ramalho, Los Angeles, CA (US)

(72) Inventor: Katrina Ramalho, Los Angeles, CA (US)

(21) Appl. No.: 14/656,130

(22) Filed: Mar. 12, 2015

Related U.S. Application Data
(60) Provisional application No. 61/953,493, filed on Mar. 14, 2014.

(51) Int. Cl. G06F 17/30; H04L 29/08

(52) U.S. Cl. CPC G06F 17/30595; H04L 67/306

(57) ABSTRACT

A computer-implemented system and method is provided that suggests recommendations of places to visit and people to connect with based on interests of users. The system and method receives a user's interests into a personal communication device including the location of interest, transmits and stores the interests on a server, identifies information relating to those interests including a suggested person to meet and a recommended destination to visit, and receives, displays and stores the identified information on the personal communication device. The system and method identifies a suggested person to meet near the location of interest by comparing the user and person's interests and determining whether they share common interests. The system and method further identifies a recommended destination to visit near the location of interest by comparing the user's interests with those of a person who rated and reviewed the destination and determining whether they share common interests.

### CROSS-REFERENCES TO RELATED APPLICATIONS

This application claims priority from U.S. Application No. 61/953,493, filed Mar. 14, 2014 incorporated by reference in its entirety.

### BACKGROUND

This invention generally relates to a social networking service, and more particularly, to a computer implemented system and method for identifying people to contact and destinations to visit based on the location and interests of a user.

Social networking services are platforms that allow users to build social relationships between people who share common interests, activities, backgrounds, or connections. Typically, these services are web-based and allow users to connect with each other over the internet. Users on a social networking service typically create a profile by providing their name, age, birthplace and interests. Users then can build their network by searching for real life connections or for other users with common locations or interests, whether domestically or internationally. Once a network is established, a user can share ideas, pictures, posts, activities, events, and interests with other people in their network.

In a location-based social networking service, users can build and interact with their network using real-time location information. Mobile phones, tablets and other personal communication devices typically include a global positioning system (GPS) that uses satellite navigation technology to track the spatial and temporal location of the device, including its current location and the time it was accessed. In the social networking context, users can incorporate the location tracking technology of their mobile devices to identify and share the location of a person, business, activity, event, or photograph to their network.

Many users rely on location-based social networking services to identify travel destinations or places to visit. For example, users frequently access social networks that incorporate crowd-sourced business reviews to identify popular locations of interest. In these applications, users typically research an establishment such as a restaurant, hotel, or entertainment venue near the user's current location by reading other users' reviews and making a choice of destination accordingly. Other social networks or applications suggest places to visit by offering special deals or coupons for certain locations for a limited time. For example, a mobile application may identify special airfare rates to travel to certain countries, or it may identify travel specials from advertisements captured by the user's mobile phone camera and thereby suggest a travelling destination. Furthermore, other social networks or applications allow users to identify destinations of interest by finding and communicating with contacts based on common group affiliations and coinciding data such as travel plans and astrological compatibility.

However, the aforementioned approaches to identifying places to visit have various flaws. For example, social networks that incorporate crowd-sourced business reviews typically are best at identifying popular locations, rather than less popular local favorites or native places to visit. Reviews can be made anonymously, and thus it is difficult to distinguish the genuine reviews from the fabricated reviews. These types of social networks also typically do not account for individual interests or tastes in their rating systems, and thus a poor rating may be difficult to categorize as due to poor quality or simply due to individual taste. It is therefore desirable to provide a social networking service that easily identifies genuine, popular destinations and local destinations while accounting for individual interest or taste.

Furthermore, identifying destinations to visit by finding and communicating with contacts having common interests is typically inefficient. The most helpful sources of finding interesting places to frequently visit are friends, families, acquaintances, and local residents. Although typical social networking services allow a user to attempt to identify a destination of interest by searching through a friend or family member's photographs or postings, this approach is problematic if the user desires to create an event or travel plan that includes several people having their own individual, and possibly conflicting, interests and tastes. Moreover, although a user who desires to travel to an international country can ask friends, family members or acquaintances to identify local places of interest, the result may prove fruitless if none of the contacts are familiar with the country, and so finding a local resident or a host or guide familiar with the location would be necessary. Therefore, it is desirable to provide a social networking service that allows users to easily find people of common interests including those willing to be a local host or guide.

Finding destinations to visit and creating travel plans with people on typical social networking services becomes even more time-consuming when multiple common interests and current location become factors. For example, a user may desire to meet and travel with people near the user's current location that have multiple common interests. Although some social networking services allow users to “check in” their location or otherwise notify others nearby of their whereabouts, it is desirable to provide a social networking service that allows users to locate people currently nearby that have specific interests. Moreover, although social networking services typically invite users to state their interests, these interests tend to be limited to static descriptions only searchable by keywords. Users who desire to find and add new people with common interests to their network typically must examine each user's individual profile, read the description, and analyze if the person has common interests. This process can prove difficult if the person has hidden their interests due to privacy concerns, or if interests are stated vaguely. Other social networking services attempt to solve this problem by allowing users to select individual interests from a list and communicate with people in a public forum that is keyed to each individual interest. However, this process is inefficient since users still must examine each user's profile to find people that exactly match the user's selected location and interests. Therefore, it is desirable to provide a social networking service that allows users to easily find other users near the user's current location having multiple common interests.

Hence, there is a need for a social networking service that easily identifies genuine, popular destinations and local destinations while accounting for individual interest or taste. There is a further need for a social networking service that allows users to search for and interact with other users based on common interests including those willing to be a local host or guide. There is further provided a need for a social networking service that allows users to easily find other users having multiple shared interests near the user's current location.

### SUMMARY OF THE INVENTION

Briefly, and in general terms, the invention provides for a computer-implemented system that provides recommendations of places to visit and people to connect with based on interests of users. In a presently preferred aspect, the system includes a first personal communication device of a first user, a second personal communication device of a second user, a server communicatively coupled to the first personal communication device and to the second personal communication device, and computer-readable instructions that perform the following steps: 1) receiving the first user's interests and the second user's interests into the personal communication devices, including the first user's location of interest; 2) transmitting to and storing each user's interests on the server; 3) identifying information relating to interests at the server; 4) receiving the identified information relating to interests from the server into the personal communication devices, and 5) displaying and storing the identified information relating to interests on the personal communication devices.

In a presently preferred embodiment, identified information relating to interests includes identification of the second user as a suggested person for the first user to meet near the first user's location of interest. The location of interest can be a specified location or the first user's current location. The second user is identified as a suggested person to meet by comparing the interests of the second user with the interests of the first user and determining if there are any common interests. If there are commonalities, the second user is identified and displayed as a suggested person for the first user to meet.

In another presently preferred embodiment, identified information relating to interests includes identification of a recommended destination to visit near the first user's location of interest that is rated and reviewed by the second user. The location of interest can be a specified location or the first user's current location. The destination is identified as a recommended destination by comparing the interests of the second user with the interests of the first user and determining if there are any common interests. If there are commonalities, the destination is identified and displayed as a recommended destination for the first user to visit. The recommended destination may include a restaurant, a lodging, a place of entertainment, nightlife, or the like.

In one presently preferred embodiment, each personal communication device includes a processor, a memory, a storage, an I/O interface, and a communication interface. In another preferred embodiment, the system includes a network that is communicatively coupled to and interfaces between the first personal communication device, the second personal communication device, and the server. In a presently preferred aspect, each personal communication device is a mobile computing device having a radio navigation system or satellite navigation system that tracks the current location of each user.

According to a preferred embodiment, each user's interests are obtained through answers to questionnaires displayed on the personal communication devices. In an embodiment, interests are general in nature and relate to food, vacation, lodging, entertainment, nightlife, sports, music, personality, lifestyle, or any conceivable category. In one preferred embodiment, the interests include identification of a user as a host user associated with at least one location who is willing to be a local host or guide for that location.

The present invention also provides for a computer-implemented method of providing recommendations for places to visit and people to connect with based on interests of users. The method includes receiving the first user's interests and the second user's interests into the personal communication devices, including the first user's location of interest; transmitting to and storing each user's interests on the server; identifying information relating to interests at the server; receiving the identified information relating to interests from the server into the personal communication devices, and displaying and storing the identified information relating to interests on the personal communication devices. In a presently preferred embodiment, identified information relating to interests includes identification of the second user as a suggested person for the first user to meet near the first user's location of interest by comparing commonalities between each users' interests. In another presently preferred embodiment, identified information relating to interests includes identification of a recommended destination to visit near the first user's location of interest that is rated and reviewed by the second user by comparing commonalities between each users' interests.

### BRIEF DESCRIPTION OF THE DRAWINGS

FIG. 1 is a schematic diagram of the architecture of a social networking service according to an embodiment of the present invention that includes multiple personal communication devices in the form of mobile devices communicatively coupled to a server through a network.

FIG. 2 is a flowchart depicting computer-readable instructions executed on a processor of the social networking service according to a preferred embodiment of the present invention that receives interests from the personal communication devices of a first and second user, transmits to and stores the interests on the server, identifies information related to the travel interests, and receives, displays, and stores the identified information on the personal communication devices.

FIG. 3 is a flowchart depicting preferred features of the social networking service according to an aspect of the present invention, including presenting questionnaires by which the social networking service receives the user's interests, and identifying and displaying information related to the interests such as the persons and destinations within a predetermined distance from the current location of the user.

FIG. 4A depicts an exemplary embodiment of a questionnaire that the social networking service displays on a personal communication device which receives food and vacation interests or preferences from a user.

FIG. 4B depicts an exemplary embodiment of a questionnaire that the social networking service displays on a personal communication device which receives lodging interests or preferences from a user.

FIG. 4C depicts an exemplary embodiment of a questionnaire that the social networking service displays on a personal communication device which receives entertainment interests or preferences from a user.

FIG. 5 illustrates an exemplary embodiment of a graphical user interface that the social networking service displays on a personal communication device by which the social networking service displays suggested persons to meet who are near the user's current location and who share the user's interests.

FIG. 6 illustrates an exemplary embodiment of a graphical user interface that the social networking service displays on a personal communication device by which the social networking service displays recommended destinations to visit who are near the user's current location.

### DETAILED DESCRIPTION OF THE PREFERRED EMBODIMENTS

As will be described hereinafter in greater detail, the various embodiments of the present invention relate to a computer-implemented system and method for recommending places to visit and people to contact or meet based on the interests of a user. For purposes of explanation, specific nomenclature is set forth to provide a thorough understanding of the present invention. Description of specific applications and methods are provided only as examples, and the general principles defined herein may be applied to other embodiments and applications without departing from the spirit and scope of the invention. Thus the present invention is not intended to be limited to the embodiments shown, but is to be accorded the widest scope consistent with the principles and steps disclosed herein.

In a preferred embodiment, the present invention provides for a social networking service that allows users to create a travel profile and upload and store their travel memories such as pictures, videos, notes, itineraries, and other related content, while allowing users to share these memories with other people in their network. The social networking service assists users in finding the best restaurants, places of entertainment, hotels and other destinations in a particular location, while allowing the user to customize destinations of interest based on the user's travel interests, general interests, hobbies, or other preferences. The social networking service provides general information regarding a travel destination and stores user-submitted ratings, reviews, photographs, and other related content to assist the user in identifying a place to visit. The social networking service also provides for users to meet other users with common interests while traveling to a particular location, including local hosts. Local hosts, discussed herein, refer to people that live in the general area of a destination, sometimes referred to as “locals,” who have registered, volunteered, or otherwise indicated on the social networking service that they are willing to provide guidance and/or travel advice to visitors.

In one embodiment, the social networking service automatically aggregates information about each user including the user's travel interests, hobbies or preferences. The social networking service also aggregates other information provided by users and third party application program interfaces (API) including each user's current location, user and destination photographs, and destination ratings and reviews. From the aggregated information, the social networking service suggests other people for the user to meet, such as local hosts or other travelers, and suggests places to eat, stay, or visit near the user's location based on the user's travel interests.

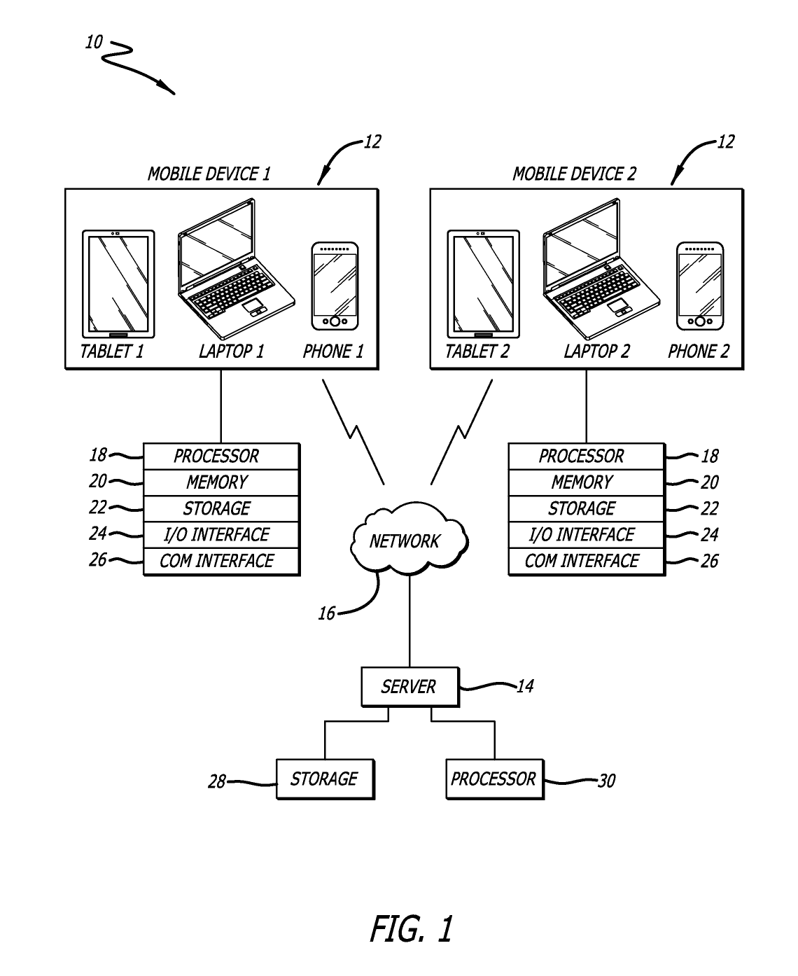

FIG. 1 illustrates a social networking service which is used according to various embodiments of the present invention. The social networking service is a computer system 10 that includes at least two personal communication devices 12 belonging to individual users that are communicatively coupled to one or more servers 14 through a network 16. Each personal communication device 12 may take any suitable form, including but not limited to, an embedded computer system, a system-on-chip (SOC), a single-board computer system (SBC) (such as, for example, a computer-on-module (COM) or system-on-module (SOM)), a server, a kiosk, a terminal, a mainframe, a mesh of computer systems, and the like. In a preferred embodiment, each personal communication device 12 is a mobile communication device or a mobile computing device, such as a laptop or notebook computer system, a cellular phone, a smart phone, a personal digital assistant, a tablet, or the like. According to an embodiment, each personal communication device 12 has a mobile phone tracking system that is used to track the personal communication device's location, thereby allowing the personal communication device 12 to transmit location information to and receive location information from the server 14. The mobile phone tracking system may be based on radio navigation (cellular towers), satellite navigation (GPS), or the like.

Each personal communication device includes a processor 18, a memory 20, a storage 22, an input/output (I/O) interface 24, and a communication (COM) interface 26 connected via a bus. Processor 18 includes hardware for executing computer-executable instructions, such as those produced by software programs. Herein, reference to software may encompass one or more applications, byte code, one or more computer programs, one or more executables, one or more instructions, logic, machine code, one or more scripts, or source code, and vice versa, where appropriate. As an example and not by way of limitation, to execute instructions, processor 18 may retrieve the instructions from an internal register, an internal cache, memory or storage, decode and execute them, and then write one or more results to an internal register, an internal cache, memory, or storage. In one embodiment, processor 18 may include one or more internal caches for data, instructions, or addresses.

Memory 20 may be random access memory (RAM), including static random access memory (SRAM) and dynamic random access memory (DRAM), read-only memory (ROM), or a persistent store, such as a mass storage device, hard drives, CD-ROM, DVD-ROM, tape, erasable programmable read-only memory (EPROM or flash memory), or any magnetic, electromagnetic, infrared, optical, or electrical system, apparatus or device for storing information. Storage 22 may be a hard drive, a floppy disk drive, flash memory, an optical disk, magnetic tape, or any other form of storage device that can store data (including instructions for execution by the processor 18). In one embodiment, storage 22 may be mass storage for data or instructions which may include, but is not limited to, a HDD, solid state drive, disk drive, flash memory, optical disc (such as a DVD, CD, Blu-ray, etc.), magnetic optical disc, magnetic tape, or any other hardware device which stores computer readable media, data and/or combinations thereof. Storage 22 may be internal or external to the personal communication device 12 and is in communication with or accessible by the personal communication device 12.

Input/output (I/O) interface 24 includes hardware, software, or both for providing one or more interfaces for communication between the personal communication device 12 and one or more I/O devices. The personal communication device 12 may have one or more of these I/O devices, where appropriate. As an example but not by way of limitation, each personal communication device 12 may include at least one mouse, keyboard, keypad, camera, microphone, monitor, display, printer, scanner, speaker, touch screen, trackball, and the like.

Communication (COM) interface 26 includes hardware, software, or both providing one or more interfaces for communication between the personal communication device 12 and the network 16. Communication interface 26 may include a network interface controller (NIC) or a network adapter for communicating with an Ethernet or other wired-based network or a wireless NIC or wireless adapter for communication with a wireless network, such as a WI-FI network. Network 16 may be a local area network (LAN), a metropolitan area network (MAN), a wide area network (WAN), an interconnection of multiple computer networks (e.g. the Internet), or any other type of network suitable for a social networking service.

The social networking service includes one or more servers 14 communicatively coupled with the personal communication devices 12 over the network 16 in order to receive, store and transmit data to and from the personal communication devices 12. The server 14 includes at least a storage 28 that stores information related to the social networking service and a processor 30 that executes instructions for the social networking service. For example, the storage 28 stores information related to users' travel interests, and the processor 30 identifies information related to users' travel interests. More servers 14 may interact with the social networking service in order to provide additional functionalities to complement the application. For example, social networking service may incorporate an additional server 14 for storing third party content for transmission to mobile devices or client computers, an additional server 14 for managing SMS messages from mobile devices, or an additional server 14 for communicating with other servers managed by cellular telephone network providers. These additional server functionalities may be separate external servers or internal components of a central server 14.

In one embodiment, social networking service is a mobile application that includes a website. Elements of the social networking service could be used to build an interactive website for travel, utilizing a computer readable medium such as a computer readable storage medium containing computer readable instructions or computer program code, or as a computer program product comprising a computer usable medium having a computer readable program code embodied therein. In the context of this document, a computer usable medium or computer readable medium may be any medium that can contain or store the program for use by or in connection with the instruction execution system, apparatus or device. The computer readable storage medium or computer usable medium may be, but is not limited to, a random access memory (RAM), read-only memory (ROM), or a persistent store, such as a mass storage device, hard drives, CD-ROM, DVD-ROM, tape, erasable programmable read-only memory (EPROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

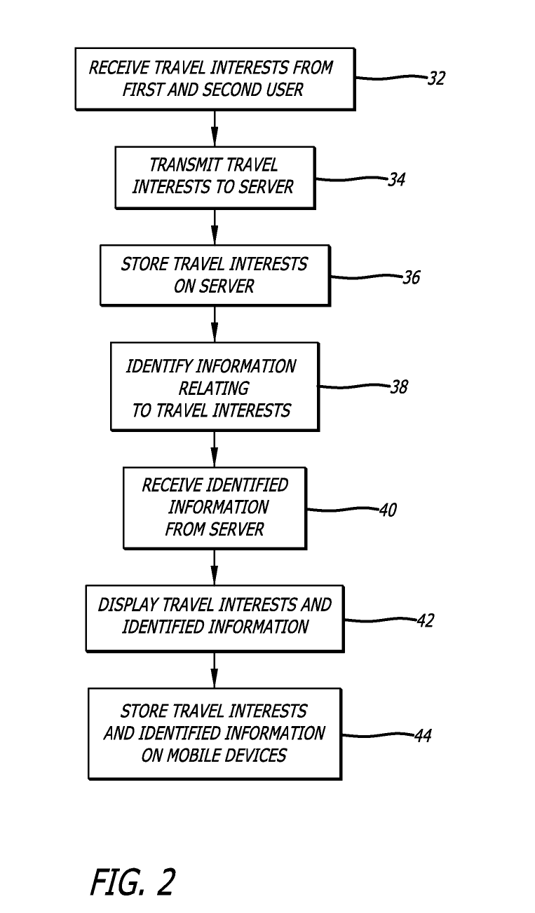

Referring to FIG. 2, the present invention provides for a social networking service or computer-implemented system and method that receives, transmits, stores, and displays interests or preferences obtained from the user, and identifies information relating to those interests. The social networking service first receives travel interests, general interests or other preferences submitted by the user into the personal communication device (32). According to one embodiment, the social networking service displays a graphical user interface 66 on the personal communication device 12 that allows the user to select one or more interests or preferences. In an exemplary embodiment, these interests are related to food, vacation, lodging, entertainment, nightlife, sports, music, personality, lifestyle, or any conceivable category, and are received as answers to one or more questionnaires (32). Examples of interests or preferences that the user may select include, but are not limited to: bikers, boaters, campers, collectors, sororities, fraternities, workout or healthy, outdoors, pet owners, yoga, LGBT, surfers, snow boarders, extreme sports, skiers, water sports, singles, family, outdoors and adventure, photographers, Christians, Polyandrist, swingers, urban, fishing, rock climbing, off roaders, green, and vegan.

According to a presently preferred embodiment, the social networking service allows a user to select as an interest or preference an identification of being a local host or host user for one or more locations. For purposes of the present invention, a host user is a person who indicates that they are local or native to a location and are willing to be a host or guide to other persons who intend to make a group travel plan or trip to the location. In an exemplary embodiment, the social networking service displays a list of locations from which the user selects one or more locations, if any, with which to be identifiably associated as a host user.

After the user provides his or her interests or preferences so that they are received into the personal communication device (32), the social networking service then transmits the interests to the server (34). In one embodiment, the interests include a location of interest to the user. The interest may be specified or selected by the user, or may be the current location of the user. In a further embodiment, the interests include identification of the user as a host user. The user's interests are stored on the server and aggregated with the stored interests of other persons on the social networking service (36).

The social networking service then identifies information relating to the aggregated interests or preferences (38). Identified information relating to interests includes recommended destinations for the user to visit based on the user's interests; for example, restaurants, lodging, and entertainment attractions and venues. Identified information relating to interests further includes suggested persons to meet who use the social networking service, that are currently located within a predetermined distance from the location of interest, and who share common interests with the user. Identified information relating to interests further includes descriptive information concerning the recommended destinations and suggested persons. Such descriptive information includes, but is not limited to, destination names and contact information such as addresses and phone numbers, destination hours of operation, destination ratings and reviews, destination travel deals or coupons, user-uploaded or third-party API provided photographs and videos of recommended destinations or suggested persons, current locations and GPS information of recommended destinations or suggested persons, suggested persons that identify themselves as host users, and relationships of suggested persons to the user such as hosts, connections or “travel buddies”, friends, followers, and persons the user is following.

The social networking service identifies information relating to travel or general interests (38), including suggested persons to meet and recommended destinations to visit, by searching the aggregated interests stored on the server 14 for commonalities. In an exemplary embodiment, the processor 30 on the server 14 identifies suggested persons to meet (38) by comparing each persons' stored interests with the stored interests of the user. The user indicates which persons for the processor 30 to compare by selecting search criteria including the location of interest, the distance from the location of interest to be searched, and the interests to compare. If the processor 30 determines after comparison that the user has any interests in common with a particular person, then the processor 30 marks that person for display on the personal communication device 12. The processor 30 then repeats this process for every person on the social networking service that fall within the search criteria until all persons having common interests have been identified. After identification is complete, the identified information of suggested persons to meet, and any identified related descriptive information, are transmitted from the server 14 and received into the user's personal communication device (40).

In a further exemplary embodiment, the processor 30 on the server 14 identifies recommended destinations to visit (38) by comparing the stored interests of the user with the stored interests of persons who rated or reviewed each destination. The user indicates which destinations for the processor 30 to identify by selecting search criteria including the location of interest, the distance from the location of interest to be searched, the destination category such as food, lodging, entertainment or nightlife, and the interests to compare. If the processor 30 determines after comparison that the user has any interests in common with a particular person who rated or reviewed a particular destination, then the processor 30 marks that destination for display on the personal communication device 12. The processor 30 then repeats this process for every destination on the social networking service that fall within the search criteria until all persons having common interests have been compared. After identification is complete, the identified information regarding recommended destinations to visit, and any identified related descriptive information, are transmitted from the server 14 and received into the user's personal communication device (40).

After the identified information relating to interests is received from the server into the personal communication device (40), the interests and identified information are displayed in a graphical user interface 66 on the personal communication device (42). In an exemplary embodiment, the identified information regarding suggested persons to meet is displayed as an interactive map that tracks the current location of each suggested person, and is displayed as a list of suggested persons with their photographs, contact information, and relationship to the user including as a host. In a further exemplary embodiment, the identified information regarding recommended destinations to visit is displayed a list of recommended destinations with their photographs, contact information, and ratings and reviews. The interests and identified information are stored in the memory and storage of the personal communication device (44), and the social networking service enables the user to use the identified information accordingly. For example, the social networking service allows the user to create a group travel plan to a recommended destination by inviting suggested persons having common interests.

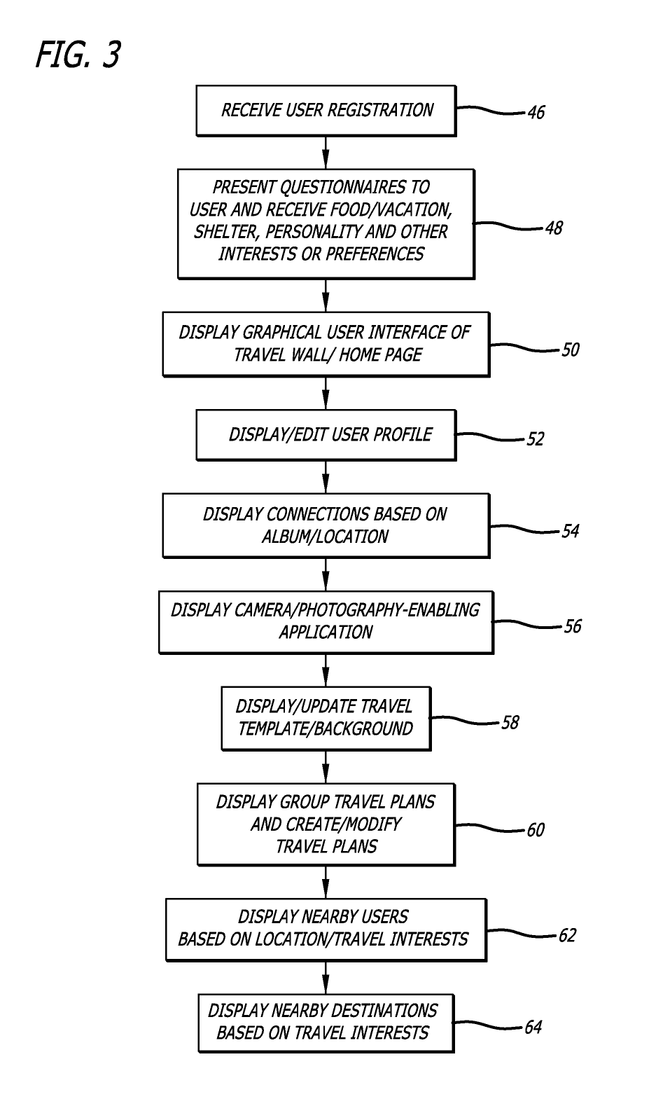

Referring to FIG. 3, the present invention provides for a social networking service that, when executed on processors 18 and 30 of the personal communication device 12 and of the server 14, provide a forum where users with common interests may meet, create travel plans, and optimize their vacations by selecting destinations to visit based on the user's interests. According to a preferred embodiment of the present invention, the social networking service receives a user's registration into the personal communication device (46), presents questionnaires to the user to receive information regarding the user's food and vacation, lodging, personality, and other interests or preferences (48), displays a main graphical user interface 66 of the home page of the application (50), displays and provides edit capability of the user's profile page (52), displays the user's connections (54), displays a camera or photography-enabled application (56), displays and provides edit capability of the user's travel template or background (58), displays and allows the user to create and modify group travel plans (60), displays nearby users based on interests (62), and displays nearby destinations based on interests (64).

The social networking service first requests a user to register an account (46). In one embodiment, the social networking service requests the user to provide a username and password. The user then customizes a profile by providing registration information and uploading a photograph to use as a profile picture. Registration information may include, but is not limited to, the user's name, gender, date of birth, hometown or place of residence, interests or preferences, and other personal information. In another embodiment, the user registers an account and subsequently logs in the social networking service using a third party application programming interface (API), for example, Facebook®. Third party APIs typically retrieve information including the user's name and contact number. The social networking service receives the information provided by the third party API, and requests the user to provide any missing or inaccurate registration information.

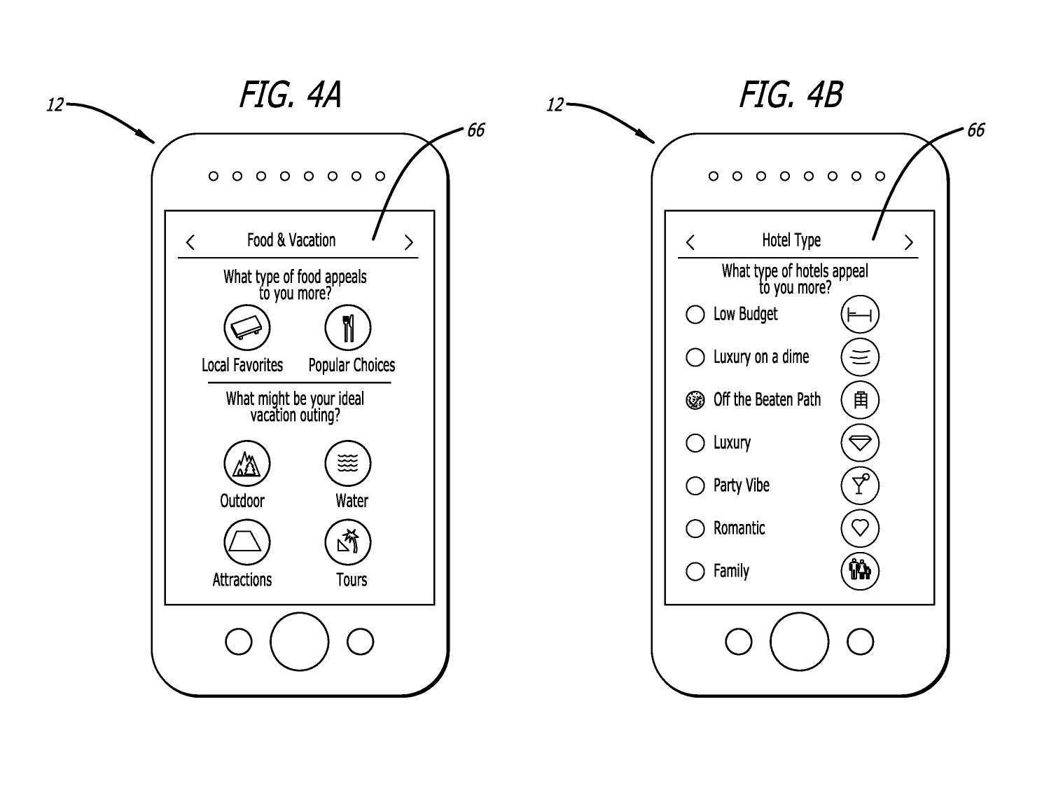

The social networking service next presents a graphical user interface 66 for the user to provide information regarding the user's interests or preferences (48). In a preferred embodiment, the graphical user interface 66 in which the user provides interest-related information includes at least one questionnaire. FIGS. 4A-4C refer to exemplary questionnaires that require the user to provide the user's food preferences, vacation interests, hotel and lodging interests or travel preferences, and personality interests. For example, in FIG. 4A, the user selects whether they prefer restaurants that are categorized as local favorites, popular favorites, or both, and whether they prefer vacation outings that are outdoors, on water, attractions, tours, or any combination of the above. In FIG. 4B, the user selects whether they prefer hotels that are categorized as low budget, “luxury on a dime”, “off the beaten path”, luxury, “party vibe”, romantic, family, or any combination of the above. In FIG. 4C, the user selects whether they prefer entertainment venues that are categorized as hip hop, house, pop, rock, Latin, LGBT, daytime jam, jazz piano bar, country, world music, or any combination of the above.

Although the exemplary questionnaires embodied herein refer to travel interests, the invention broadly encompasses general interests in any conceivable category. For example, the user may provide food and restaurant preferences such as cuisine, gourmet, or adventurous; lodging preferences such as hotels, room rentals, hostels, inns, or apartments; quality preferences such as low budget or luxury; atmosphere preferences such as party, romantic, or family; music preferences such as hip hop, house, pop, or rock; entertainment preferences such as outdoor activities, tours, attractions, theme parks, water activities, beaches, hikes, nature, or museums; vacation styles such as leisurely or active; sports preferences such as basketball, baseball, football, or soccer; hobby preferences such as backpacking, surfing, or mountain climbing; and personality, lifestyle, or miscellaneous preferences such as adventurous, bibliophilic, LGBT, thrill-seeking, or nerdy. In one embodiment, the social networking allows users to select interests through a drop down menu. In an alternative embodiment, the social networking service allows users to select interests from a list using selectable buttons or checkboxes.

After the user answers the questionnaires, the social networking service displays a graphical user interface 66 that depicts the user's home page (50). In one embodiment, the home page is a “travel wall” that contains a plurality of actuatable or selectable elements and that presents the most recent uploaded photographs and/or videos from other users. The social networking service allows the users to tag each photograph or video with location information obtained from the personal communication device 12. In another embodiment, the social networking service allows users to tag each photograph or video with current weather information obtained from a third party API.

In an exemplary embodiment, the graphical user interface 66 displays postings and photographs of destinations from users all over the world. In one embodiment, the graphical user interface 66 is filtered to only display postings and photographs of destinations from connections. In another embodiment, the graphical user interface 66 is filtered to only display postings and photographs of destinations from users having common interests.

According to one embodiment, the selectable elements on the graphical user interface 66 include a refresh element that refreshes the graphical user interface 66 with updated information, such as users' most recent uploaded photographs. In an alternative embodiment, the graphical user interface 66 automatically refreshes at regular intervals or upon a certain user action. In one embodiment, the graphical user interface 66 has actuatable elements that allow a user to provide a posting or status update, approve or “like” a user's photograph or posting and provide comments, and share a photograph or video to a third party website or social network. According to one embodiment, the social networking service displays the user's profile picture. In an embodiment, the user's profile picture is an actuatable or selectable element.

According to an embodiment, the graphical user interface 66 displays selectable navigation elements that direct the user to various features of the social networking service, including the home page, the user's profile page, a list of the user's connections in the user's social network, a camera page that activates a camera on the personal communication device 12 or links to a photography-enabled application, a group travel plan page that allows the user to create customized trips and invite other people to the trips, a travel templates page that allows the user to change the background of the user's profile using multiple image templates, a meet and greet page that depicts persons within a predetermined distance of the user's location, a places page depicting destinations to visit within a predetermined distance from the user's location, a connection invitation page that invites new users to the social network through a third party API, a printing page that allows the user to physically print photographs through a third party API, and a messaging page that allows the user to contact the user's connections.

The social networking service next allows the user to view and edit the user's profile (52). When the user selects the user's profile picture, the social networking service displays a graphical user interface 66 that depicts the user's profile. In one embodiment, the user's profile includes an interactive map that displays all the places that the user has visited. The social networking service updates the interactive map with the locations it receives from the user's activity, for example, the user's notifications of places visited (i.e. “check ins”), the user's uploaded photographs, or the user's postings. In a further embodiment, the user's profile displays the current location of the personal communication device 12.

In one embodiment, the social networking service allows the user to edit the user's profile (52). For example, the social networking service allows the user to update or change their username, profile picture, gender, age, interests, hometown, and other personal information. In an embodiment, the social networking service allows the user to automatically update location-based personal information such as hometown using the current location of the personal communication device 12.

In one embodiment, the user's profile includes a list of all the user's social or travel connections on the social networking service, including connections who are following the user or who the user is following, and allows the user to search for and add new connections to the user's social network. In an embodiment, the social networking service allows the user to add new connections identified by relationship, such as persons the user is following, connections, and hosts. In a further embodiment, the user's profile includes actuatable or selectable photographs of the user's connections that allow the user to view the profile page of each connection and to contact each connection.

In another embodiment, the user's profile further includes one or more albums of photographs or videos of places the user has visited that the user has uploaded to the social networking service, for example using a photography-enabling application or camera. The albums include descriptive material such as the location of the album that is represented in the photographs, the date the photographs were taken and the album was created, the number of photographs in the album, and the connections “tagged” (i.e. featured) in the photographs. In one embodiment, the user's profile includes the user's total number of followers, photographs, locations visited, and trips planned. In a further embodiment, the social networking service displays a preview of each album on the user's profile page.

The social networking service further displays a list of all connections that the user has added to his or her social network (54). In one embodiment, the connections are categorized by album or location based on the photographs in which the connections are tagged. In a further embodiment, the connections' names are displayed next to their individual profile pictures, and the connections' profile pictures may be cropped into a circular shape or any other geometric shape. According to another embodiment, the connections' profile pictures are actuatable or selectable, such that when the user selects a connection's profile picture, the social networking service allows the user to contact the connection through a messaging interface. Alternatively, the social networking service displays the connection's profile page when the user selects the connection's profile picture. In another embodiment, the social networking service allows the user to publicize or hide the list of connections to other people who view the user's profile.

The social networking service further displays a camera or photography enabling application (56). In one embodiment, the social networking service interfaces directly with a camera built into the personal communication device 12. Alternatively, the social networking service includes a separate photography-enabling application that implements camera functionality. The camera or photography-enabling application includes adjustable settings, including filters and cropping. When the user desires to transmit a photograph to the social networking service, the social networking service allows the user to take a photograph using the camera, to filter or crop the photograph, and optionally, to specify a nearby location to associate with the photograph. Afterwards, the social networking service receives the photograph and processes it accordingly, for example, by posting the photograph on the user's home page, replacing the user's profile picture with the photograph, associating the photograph with an album, transforming the photograph into a background, or sharing the photograph with a third party API or social network.

The social networking service further displays and allows the user to update the user's template or background (58). In a preferred embodiment, the user selects a background or template to incorporate as the user's theme in the graphical user interface 66 of the social networking service. In one embodiment, the background or template is selected from a predetermined list of stock photographs. In another embodiment, the background or template is selected from a list of photographs uploaded or submitted by the users of the social networking service. In a further embodiment, each background is categorized by location. The social networking service allows the user to replace the user's current template or background by selecting a new template or background. In a further embodiment, the social networking service allows the user to post the template or background on the user's home page with a customized message. According to a further embodiment, the social networking service allows the user to share the template with a third party API or social network, and optionally, to specify a nearby location to associate with the template.

The social networking service further includes a graphical user interface 66 that displays, and allows the user to create and modify, group travel plans (60). A group travel plan is a customized and planned trip by at least two users to a location of interest, such as a city or country. The social networking service allows the user to create a group travel plan by specifying the location and the dates of travel, and by creating a collage of pictures from various predetermined designs that depict the location using photographs accessed from the user's albums or camera application. In a further embodiment, the social networking service allows the user to post a photograph on the travel wall with comments describing the group travel plan. According to a further embodiment, the social networking service displays travel advertisements on the graphical user interface which advertise locations of interest, for example cities and countries, or destinations to visit, such as restaurants, hotels and entertainment venues.

In a preferred embodiment, the social networking service allows the user to invite other people to join in the group travel plan, for example to invite friends on a trip away. In one embodiment, each invitation includes a hyperlink to a third party website associated with a destination or place to visit at the location, for example, a hotel, restaurant, or entertainment venue. In an alternative embodiment, the hyperlink is displayed in each invitation as a sponsored advertisement banner. In a further embodiment, the social networking service allows the user to select places to visit and activities to do at the location for other persons to choose in each invitation. In a further embodiment, the social networking service provides recommendations of places to visit and activities to do based on the interests or preferences of each user in each invitation. In a preferred embodiment, the social networking service allows the user to invite another person to the group travel plan who identifies themselves as a host user.

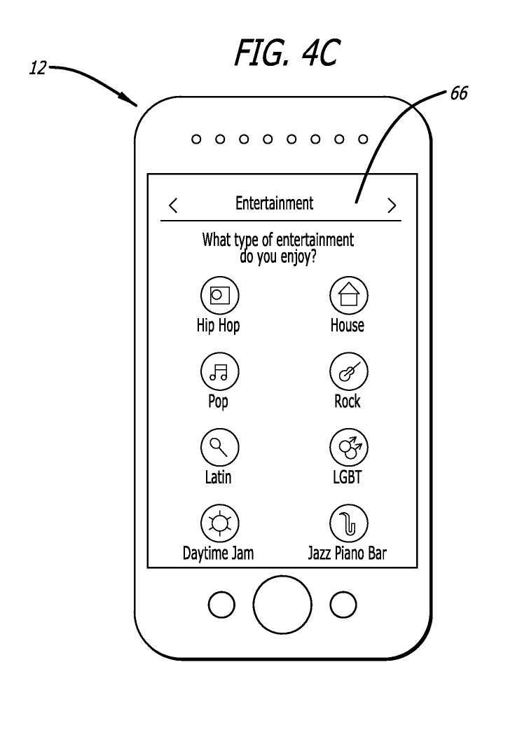

Referring to FIG. 5, the social networking service further provides a graphical user interface 66 that displays suggested persons for the user to meet based on location and interest (62). In a preferred embodiment, the social networking service displays an interactive map depicting the user's location of interest 68 and a list of suggested persons to meet 70 currently within a predetermined distance from the user's location of interest 68 who share common interests with the user. The social networking service obtains the predetermined distance from the user, for example, by allowing the user to provide a mileage number or range. In a preferred embodiment, the social networking service obtains the current location of the user as the location of interest 68 from the spatial and temporal information transmitted from and received by the radio navigation systems or satellite navigation systems in the personal communication device 12. In a further embodiment, the social networking service allows the user to provide a specified location as the location of interest 68. The social networking service then uses this information to display the user's location of interest 68 and the suggested persons' locations on the graphical user interface 66.

The graphical user interface 66 displays information about each suggested person to meet such as their name, current location, and relationship to the user. Relationships, for example, include followers of the user, people that the user is following, connections or “travel buddies”, friends, and hosts. In one embodiment, the graphical user interface 66 displays profile pictures next to each person. In another embodiment, each profile picture is actuatable or selectable, such that when the user selects another person's profile picture, the social networking service allows the user to contact the person through a messaging interface. Alternatively, the graphical user interface 66 displays the person's profile page when the user selects the person's profile picture.

The social networking service allows a user to search for suggested persons to meet based on several search criteria. In an exemplary embodiment, the social networking service allows a user to search for persons within a predetermined distance from the user's location of interest 68 based on criteria such as distance, gender, age, name, and relationship. According to an embodiment, the location of interest 68 is a search criteria. According to an alternative embodiment, the location of interest 68 is the current location of the user.

In a preferred embodiment, the social networking service allows a user to search for suggested persons to meet 70 by interest or preference. According to one embodiment, the social networking service allows the user to search for suggested persons to meet 70 by selecting one or more interests from a list 72. In another embodiment, the social networking service searches for suggested persons to meet 70 using the interest criteria that the user previously submitted in response to the questionnaires. When the user provides the interest criteria to the social networking service, the social networking service accesses the interests of persons within a predetermined distance from the user's location of interest 68 that are stored on the server 14. The social networking service then compares the interests that the user provided with the other persons' interests, and identifies people that have common interests. Afterwards, the social networking service displays on the graphical user interface 66 the list of suggested persons to meet 70 sharing common interests who are within the predetermined distance of the user's location of interest 68.

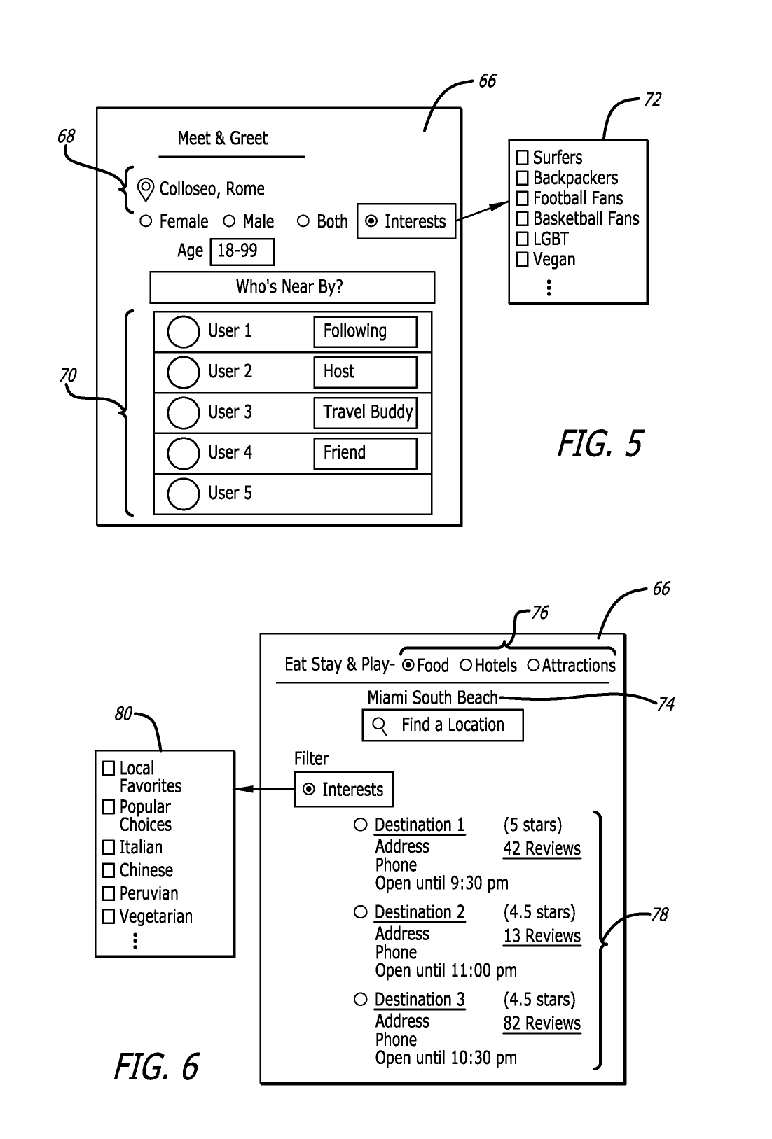

Referring to FIG. 6, the social networking service further provides a graphical user interface 66 that displays recommended destinations to visit based on location and interest (64). In a preferred embodiment, the social networking service allows the user to search for, rate, and review destinations to visit within a predetermined distance from the user's location of interest 74, including restaurants and other places to eat, hotels and other places to sleep, and attractions, nightlife, or other forms of entertainment. The social networking service obtains the predetermined distance from the user, for example, by allowing the user to provide a mileage number or range. Furthermore, in a preferred embodiment, the social networking service obtains the current location of the user as the location of interest 74 from the spatial and temporal information transmitted from and received by the global positioning systems in the personal communication device 12. In a further embodiment, the social networking service allows the user to provide a specified location as the location of interest 74.

The social networking service displays the user's current or specified location of interest 74, the user's selected destination category 76 such as food, hotel and attractions, and the list of destinations 78 within a predetermined distance from the location of interest 74. According to an embodiment, the social networking service obtains destinations 78 to display from a third party API. In a further embodiment, the social networking service obtains destinations 78 to display from user submissions. In an exemplary embodiment, the social networking service provides actuatable or selectable elements that allow the user to sort the list of destinations 78 by price, rating, reviews or comments, whether open for business, or related sorting categories. In a further embodiment, the social networking service sorts the list of destinations 78 by interest.

Each destination 78 includes descriptive information such as the name of the destination, the address and phone number, the hours of operation, ratings and reviews, and any photographs of the destination. In an embodiment, the social networking service displays the descriptive information next to each destination 78. In another embodiment, the social networking service displays a preview of the list of destinations 78 and provides actuatable or selectable elements that allow the user to display the descriptive information for each destination in a separate window. In a further embodiment, the descriptive information includes hyperlinks to a third party website associated with the destination 78, such as a hotel.

The social networking service allows the user to search for destinations 78 near the user's location of interest 74 using several search criteria. In an exemplary embodiment, the social networking service allows the user to search by distance, rating, price, and whether the destination is currently open. In an alternative embodiment, the social networking service provides location of interest 74 as a search criteria so that a user can look for destinations near a specified location.

In a preferred embodiment, the social networking service allows a user to search for destinations near the current location of the user by interest or preference. According to one embodiment, the social networking service allows the user to search for nearby destinations by selecting one or more interests from a list 80. In another embodiment, the social networking service searches for nearby destinations using the interest criteria that the user previously submitted in response to the questionnaires. When the user provides the interest criteria to the social networking service, the social networking service accesses the interests of persons who reviewed the destination that are stored on the server 14. The social networking service then compares the interests that the user provided with the other persons' interests, and identifies people that have common interests. The social networking service subsequently ranks destinations by the number of positive ratings submitted by persons having common interests with the user. Afterwards, the social networking service displays on the personal communication device 12 the list of destinations 78 sorted by rank.

For example, if the user indicated to the social networking service that the user is interested in local favorites as opposed to popular choices, then the social networking service determines restaurants that are local favorites by identifying persons who also indicated they are interested in local favorites, identifying the destinations that those persons have rated and/or reviewed, and displaying the destinations to the user sorted by rank according to the number of positive ratings. The same process applies to popular choices, hotels, places of entertainment, or other destinations of interest.

While particular embodiments of the present invention have been described, it is understood that various different modifications within the scope and spirit of the invention are possible.

I claim:

1. A computer-implemented system that provides recommendations of places to visit and people to connect with based on interests of users, the system comprising:
a first personal communication device of a first user and a second personal communication device of a second user;
a server communicatively coupled to the first personal communication device and to the second personal communication device;
computer-readable instructions that, when executed on a processor, perform the steps of:
receiving a plurality of first interests from the first user into the first personal communication device and a plurality of second interests from the second user into the second personal communication device, wherein the plurality of first interests includes a location of interest to the first user;
transmitting the plurality of first interests from the first personal communication device and the plurality of second interests from the second personal communication device to the server;
storing the plurality of first interests and the plurality of second interests on the server;
identifying information relating to interests at the server from the plurality of first interests and the plurality of second interests, wherein the identified information includes identification to the first user of at least one suggested person to meet who is currently within a predetermined distance from the location of interest, and wherein the second user is identified to the first user as the at least one suggested person to meet by comparing commonalities between the plurality of first interests and the plurality of second interests;
receiving into the first personal communication device and the second personal communication device the identified information relating to interests from the server;
displaying the plurality of first interests, the plurality of second interests, and the identified information relating to interests in a graphical user interface rendered on the first personal communication device and on the second personal communication device; and
storing the plurality of first interests, the plurality of second interests, and the identified information relating to interests on the first personal communication device and on the second personal communication device.

2. The system of claim 1, wherein each personal communication device comprises a processor, a memory, a storage, an I/O interface, and a communication interface.

3. The system of claim 1, further comprising a network that is communicatively coupled to and interfaces between the first personal communication device, the second personal communication device, and the server.

4. The system of claim 1, wherein the first personal communication device is a mobile computing device.

5. The system of claim 4, wherein the location of interest is the current location of the first user.

6. The system of claim 1, wherein the plurality of first interests are obtained through answers to questionnaires displayed on the first personal communication device, and wherein the plurality of second interests are obtained through answers to questionnaires displayed on the second personal communication device.

7. The system of claim 1, wherein the plurality of second interests includes identification of the second user as a host user for at least one location.

8. The system of claim 1, wherein the identified information relating to interests includes descriptive information of the at least one suggested person to meet.

9. The system of claim 1, wherein the identified information relating to interests includes identification of a recommended destination to visit within a predetermined distance from the location of interest that is rated and reviewed by the second user, wherein the recommended destination is identified to the first user by comparing commonalities between the plurality of first interests and the plurality of second interests.

10. The system of claim 9, wherein the recommended destination is selected from the group consisting of a restaurant, a lodging, and a place of entertainment.

11. The system of claim 9, wherein the identified information relating to interests includes descriptive information of the recommended destination.

12. A computer-implemented method of providing recommendations for places to visit and people to connect with based on interests of users, the method comprising executing on a processor the steps of:
receiving a plurality of first interests from a first user into a first personal communication device and a plurality of second interests from a second user into a second personal communication device, wherein the plurality of first interests includes a location of interest to the first user;
transmitting the plurality of first interests and the plurality of second interests to a server;
storing the plurality of first interests and the plurality of second interests on the server;
identifying information relating to interests at the server from the plurality of first interests and the plurality of second interests, wherein the identified information includes identification to the first user of at least one suggested person to meet who is currently within a predetermined distance from the location of interest, and wherein the second user is identified to the first user as the at least one suggested person to meet by comparing commonalities between the plurality of first interests and the plurality of second interests;
receiving from the server the identified information relating to interests;
displaying the plurality of first interests, the plurality of second interests, and the identified information relating to interests; and
storing the plurality of first interests, the plurality of second interests, and the identified information relating to interests on the first personal communication device and on the second personal communication device.

13. The method of claim 12, wherein the first personal communication device is a mobile computing device.

14. The method of claim 13, wherein the location of interest is the current location of the first user.

15. The method of claim 12, further comprising obtaining the plurality of first interests from the first user through answers to questionnaires displayed on the first personal communication device, and obtaining the plurality of second interests from the second user through answers to questionnaires displayed on the second personal communication device.

16. The method of claim 12, further comprising receiving from the second user identification of the second user as a host user for at least one location.

17. The method of claim 12, further comprising identifying descriptive information of the at least one suggested person to meet.

18. The method of claim 12, further comprising identifying a recommended destination to visit within a predetermined distance from the location of interest that is rated and reviewed by the second user, wherein the recommended destination is identified to the first user by comparing commonalities between the plurality of first interests and the plurality of second interests.

19. The method of claim 18, wherein the recommended destination is selected from the group consisting of a restaurant, a lodging, and a place of entertainment.

20. The method of claim 18, further comprising identifying descriptive information of the recommended destination.
